(19) United States
(12) Patent Application Publication
(10) Pub. No.: US 2026/0039082 A1
(43) Pub. Date: Feb. 5, 2026

(54) CLADDING PUMPED DISTRIBUTED RAMAN AMPLIFIER FOR MULTI-CORE-FIBER TRANSMISSION

(71) Applicant: II-VI Delaware, Inc., Wilmington, DE (US)

(72) Inventors: Ian Peter McClean, Brixham (GB); Nadhum Kadhum Zayer, Devon (GB); Jean Axel Edmond Teissier, Huningue (FR)

(21) Appl. No.: 18/792,840

(22) Filed: Aug. 2, 2024

(51) Int. Cl. H01S 3/30; H01S 3/067; H01S 3/094

(52) U.S. Cl. CPC H01S 3/302; H01S 3/06708; H01S 3/094007; H01S 3/094046

(57) ABSTRACT

A device, system, and method for distributed Raman amplification of a multi-core fiber (MCF) is disclosed. The optical amplifier device includes a plurality of single mode optical pumps configured to supply one or more wavelengths to a depolarizer and a mode multiplexer configured to receive the one or more wavelengths from the depolarizer to output at least one combined depolarized optical light comprising the one or more wavelengths. The device also includes a coupler to couple the at least one combined depolarized optical light into MCF. The combined depolarized optical light Raman amplifies an optical signal in the MCF.

### FIELD

The embodiments disclosed herein are in the field of optic communication devices used in optical systems. More particularly, the embodiments disclosed herein relate to a Raman optical amplifier device used in multi-core fiber devices and systems.

### BACKGROUND

Unless otherwise indicated herein, the materials described herein are not prior art to the claims in the present application and are not admitted being prior art by inclusion in this section. Existing long-distance optical communication system devices that use multi-core fiber (MCF) implement repeaters periodically disposed along the length of the MCF in order to maintain signal strength and integrity. In particular, in some terrestrial applications, in order to increase signal capacity, additional MCFs may be laid over existing MCFs on land. However, in submarine applications, in which one or more bundles of MCFs are on the sea floor, increasing signal capacity cannot be economically achieved by simply laying additional MCFs.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

Embodiments are directed to optical amplifier devices, optical amplifier systems, and methods for providing distributed Raman amplification in a MCF.

In one aspect, embodiments are directed to an optical amplifier device that includes a plurality of single mode optical pumps configured to supply one or more wavelengths. Embodiments may include a depolarizer and a mode multiplexer configured to receive the one or more wavelengths from the depolarizer to output at least one combined depolarized Raman pump light comprising the one or more wavelengths. In another aspect of the disclosure, disclosed optical amplifier devices also include a coupler configured to couple the at least one combined depolarized Raman pump light into a MCF. In one example, the combined depolarized Raman pump light Raman amplifies an optical signal in the MCF.

In example disclosed optical amplifier devices, a coupler may couple at least one combined depolarized Raman pump light into cladding of the MCF. The coupler, in one example, may be a fan-in/fan-out coupler including at least one single core fiber configured to couple into cladding of the MCF.

Embodiments of the optical amplifier device may include a mode multiplexer. Such a mode multiplexer may include a plurality of multiplexers that output a plurality of the combined depolarized Raman pump light. The coupler may be a fan-in/fan-out coupler that includes a single core fiber for each of the plurality of combined depolarized Raman pump light. A plurality of single mode optical pumps may Raman amplify optical signals in one or more transmission cores of the MCF.

In another aspect, embodiments are directed to optical amplifier systems that include a MCF with one or more transmission cores and cladding. The system includes a plurality of single mode optical pumps configured to supply one or more wavelengths to a depolarizer and may include a mode multiplexer configured to receive the one or more wavelengths from the depolarizer to output at least one combined depolarized Raman pump light comprising the one or more wavelengths. The system also includes a coupler configured to couple the at least one combined depolarized Raman pump light into the cladding of the MCF. The combined depolarized Raman pump light provides stimulated Raman amplification to an optical signal in one or more of the transmission cores.

In the disclosed systems, the coupler may be a fan-in/fan-out coupler comprising at least one single core fiber configured to couple into the cladding of the MCF.

In the disclosed systems, the mode multiplexer may include a plurality of multiplexers that output a plurality of the combined depolarized Raman pump light. The coupler may be a fan-in/fan-out coupler that includes a single core fiber for each of the plurality of combined depolarized Raman pump light. Each of the single core fibers are configured to couple into the cladding of the MCF.

In another aspect of the disclosure, embodiments are directed to methods of providing distributed Raman amplification in a MCF that includes transmitting a plurality of single mode optical pump signals of one or more wavelengths to a depolarizer and a mode multiplexer receiving the one or more wavelengths. The one or more wavelengths are multiplexed and at least one combined depolarized Raman pump light that includes the one or more wavelengths are transmitted to a coupler. The coupler couples the at least one combined depolarized Raman pump light into cladding of the MCF, and an optical signal in one or more transmission cores of the MCF is amplified by stimulated Raman amplification with the combined depolarized Raman pump light.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a schematic diagram illustrating a cross section of an MCF in accordance with embodiments herein;

FIG. 2 is a schematic diagram illustrating an exemplary optical amplifier system;

FIG. 3 is a schematic diagram illustrating another exemplary optical amplifier device in accordance with embodiments; and

FIGS. 4A and 4B illustrate examples of different photonic couplers in accordance with embodiments herein.

### DETAILED DESCRIPTION

It is to be understood that the figures and descriptions of the present disclosure may have been simplified to illustrate elements that are relevant for a clear understanding of the present embodiments, while eliminating, for purposes of clarity, other elements found in an optical amplifier device, optical amplifier assembly, and system using an optical amplifier device. Those of ordinary skill in the art will recognize that other elements may be desirable and/or required in order to implement the present embodiments. However, because such elements are well known in the art, and because they do not facilitate a better understanding of the present embodiments, a discussion of such elements is not provided herein. It is also to be understood that the drawings included herewith only provide diagrammatic representations of the presently preferred structures of the present disclosure and that structures falling within the scope of the present embodiments may include structures different than those shown in the drawings. Reference will now be made to the drawings wherein like structures are provided with like reference designations.

As discussed above, there are many situations in which it is difficult, infeasible, or cost prohibitive to lay additional fibers for additional signal capacity. In addition, there are also cases in which amplification may be necessary due to a greater distance between optical nodes. Raman amplification can be used to improve the optical noise in a system such that the data signals may travel farther. Raman amplification may also be used to obtain higher data rates over a given distance of fiber. Accordingly, disclosed herein are solutions that increase signal capacity along MCFs that may currently exist over long distances, or accommodate greater distances, with minimal fiber introduction. Embodiments can provide Raman amplification for MCFs using only a single Raman amplifier, rather than separate amplifiers for each core in the MCF. Embodiments may also provide the advantage of an increased signal density over MCFs, which reduces the amount of MCF required to be installed for signal needs.

Presently, spatial division multiplexing (SDM) is used to increase signal transmission capacity for optical fibers, which requires the use of optical amplifiers periodically distributed along a length of the optical fiber. In some SDM applications, an Erbium Doped Fiber Amplifier (EDFA) is used as the optical amplifier, in which the optical fiber is core-pumped with laser light. However, in submarine applications, which use existing MCF's, implementing SDM would require a periodic distribution of optical amplifiers along an entirety of the MCF's. In reality, lengths of submarine optical fiber cables can vary between a few kilometers to hundreds and thousands of kilometers. Accordingly, a solution is required that increases signal transmission capacity along MCFs over long distances, without adding additional optical components, such as optical amplifiers, distributed along the length of the MCF.

The subject matter claimed herein is not limited to implementations that solve any disadvantages or that operate only in environments such as those described above. Rather, this background is only provided to illustrate one example technology area where some implementations described herein may be practiced.

These and other advantages of the present disclosure will become more fully apparent from the detailed description of the invention herein below.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In general, embodiments disclosed herein are directed to devices and systems for Raman amplifying signals in a MCF. In disclosed embodiments, multi-mode stimulated Raman activity of the cladding is used to amplify data channels in different transmission cores within the MCF. Embodiments may have the advantage of being able to amplify optical signals in existing, difficult to access MCFs.

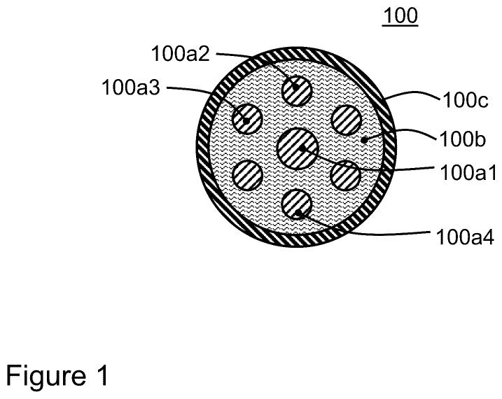

FIG. 1 is a schematic diagram illustrating a cross section of a MCF normal to its longitudinal axis in accordance with embodiments herein. The MCF 100 has multiple undoped transmission cores 100a1-4 surrounded by a common cladding 100b, which is surrounded by a casing 100c. Each of the transmission cores 100a1-4 has an index of refraction for the transmission of its optical signals. The cladding 100b has an index of refraction for counter-propagated Raman excitation transmissions. The MCF 100 may be fabricated to transmit multi-mode Raman pump light via the cladding 100b. The multi-mode Raman pump light provides distributed Raman amplification of the optical signals in the transmission cores 100a1-4. Accordingly, only one Raman amplifier may be used/needed for all the cores in an MCF.

The example MCF 100 includes a transmission core 100a1 that is a multi-mode core having a first diameter surround by transmission cores 100a2-4 that are single-mode cores, each having a second diameter smaller than the first diameter. However, embodiments are not limited as such. The MCF may include transmission cores of different sizes and different positional arrangements within the casing. Further, the transmission cores may be coupled or uncoupled in accordance with embodiments.

For example, transmission core 100a1 may have a larger radius (e.g., multi-mode) than a transmission core 100a2 (e.g., single mode), as shown in FIG. 1. As another example, the MCF may include coupled transmission cores. For example, the transmission core 100a2 may be coupled with transmission core 100a3, but not transmission core 100a4. In the coupled core fiber, the transmission cores 100a2, 100a3 are arranged to be spatially grouped, i.e., separate from a group including transmission core 100a4.

In some implementations, the transmission cores 100a1-4 may include fibers operating in a 1400-1600 nm range, for example C-band and/or L-band transmissions. One of ordinary skill in the art will appreciate that the transmission cores 100a1-4 may include different combinations and arrangements of multi-mode cores and single mode cores, some of which may be coupled, within the casing 100c. In accordance with embodiments, the cladding 100b may be made of a material that supports distributed Raman amplification in a bandwidth that includes the optical signals to be amplified. For example, silica based fiber cladding with low losses in the 1550 nm range may be used for amplification in the C and L bands of the spectrum. Embodiments are not limited solely to the use of silica-based fibers for the C and L bands, as embodiments could also benefit other systems, such as fluoride based fibers in the 2000 nm range.

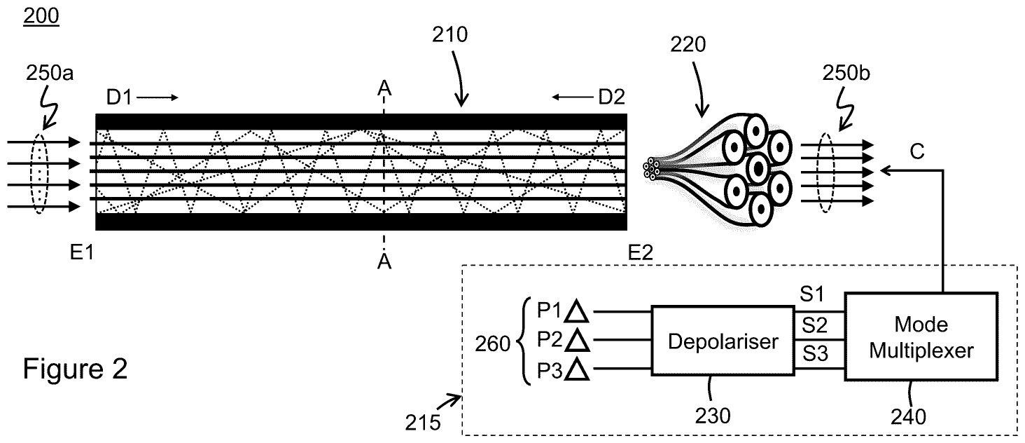

FIG. 2 is a schematic diagram illustrating an exemplary optical amplifier system. In FIG. 2, the optical amplifier system 200 includes an MCF 210 (in accordance with FIG. 1) and a pump source 215 that includes a pump source 215, a depolarizer 230, and a mode multiplexer 240. The optical amplifier system also include a fiber coupler 220. The MCF 210 is configured to pass optical signals 250a from one end E1 to another end E2 along the transmission cores of the MFC 210 along a first direction D1. The perspective of the MFC 210 shown in FIG. 1 is illustrated in the A-A plane of the optical amplifier system 200 of FIG. 2. In FIG. 2, the pump source 215 may include one or more single mode and/or multi-mode light sources to provide the Raman amplification in accordance with embodiments.

In the example of FIG. 2, single mode optical pumps 260 are configured to provide individual optical pump lights with different wavelengths that are input into the depolarizer 230. The optical pumps 260 may each include one or more single mode laser diodes P1, P2, P3. Here, each of the laser diodes P1, P2, P3 are selected and configured to produce the optical pump light S1, S2, S3, respectively, over a wavelength range to Raman amplify the optical signals 250a.

Embodiments are not limited to a single optical pump, e.g., optical pump light S1, for each amplified channel/transmission core. The number and wavelengths of the one or more laser diodes P1, P2, P3 and optical pump light S1, S2, S3 may be varied based on numerous factors, such as relative wavelengths of different transmission cores; power requirements; the number, arrangement, and materials of the transmission cores and cladding of the MCF; as well as other operational factors (temperature, etc.). In some embodiments, the pump source 215 may include one or more multi-mode optical pump light sources that may be depolarized/mode multiplexed, as necessary. One skilled in the art will recognize that one or more appropriate multi-mode optical pump light sources may eliminate the need for a multiplexer.

In FIG. 2, the depolarizer 230 is optically coupled to the optical pumps 260, and the depolarizer 230 is configured to remove polarization from the optical pump light produced by the optical pumps 260 and pass the depolarized optical light S1, S2, S3 to the mode multiplexer 240. The mode multiplexer 240 is optically coupled to the depolarizer 230, and the mode multiplexer 240 combines the individual depolarized optical pump light S1, S2, S3 and outputs a combined depolarized optical light C to the MCF 210 via the optical coupler 220, which is optically coupled to the mode multiplexer 240. In the example of FIG. 2, the optical pump light S1, S2, S3 is transmitted to the depolarizer 230 and then to the mode multiplexer 240; however, embodiments are not limited as such. The pump light could be multiplexed prior to the depolarization.

In particular, a combined depolarized optical light C is optically coupled to and supplied to the MCF 210 through the fiber coupler 220. The combined depolarized optical light C is transmitted along a second direction D2 through the MCF 210, which is substantially opposite to the first direction D1. Although the combined depolarized optical light C is shown counter-propagating to the optical signals 250a in FIG. 2, the combined depolarized optical light may also be transmitted in the same direction of the optical signals 250a in accordance with embodiments herein. In FIG. 2, the Raman amplified signals 250b from the individual cores are established due to the distributed Raman amplification in the MCF 210.

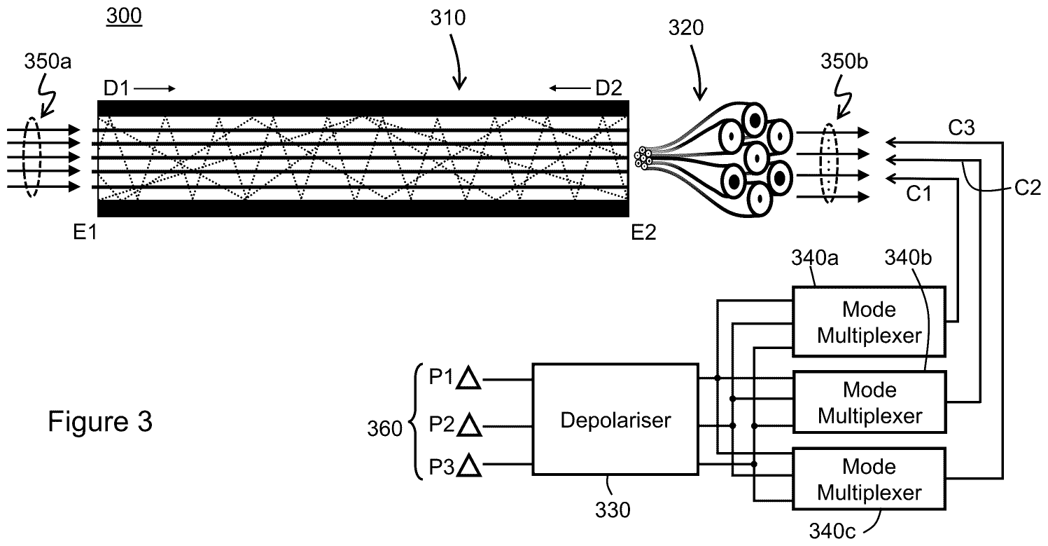

FIG. 3 is a schematic diagram illustrating another exemplary optical amplifier device in accordance with embodiments. In FIG. 3, the optical amplifier device 300 includes an MCF 310, a fiber coupler 320, and a depolarizer 330. The MCF 310 is configured to pass optical signals 350a from one end E1 to another end E2 along the transmission cores of the MFC 300 along a first direction D1.

Similar to FIG. 2, FIG. 3 includes one or more optical pumps 360 configured to provide individual optical pump light with different wavelengths that are input into the depolarizer 330, which is optically coupled to the single mode optical pumps 360. The depolarizer 330 may include an individual depolarizing component for each optical pump light. The number and wavelength of the optical pumps 360 are selected to Raman amplify the optical signals 350a. The depolarizer 330 is configured to remove any polarization from the optical pump light S1, S2, S3 produced by the optical pumps 360 and pass the depolarized optical light to one or more mode multiplexers 340, which are optically coupled to the depolarizer 330.

In the embodiments of FIG. 3, multiple mode multiplexers 340a . . . 340c are used to combine the individual depolarized optical pump light S1, S2, S3 and output multiple combined depolarized optical light C1 . . . C3 to the MCF 310 via the optical coupler 320. The coupled depolarized optical light C1 . . . C3 are transmitted through the MCF 310. In FIG. 3, depolarized optical light C1 . . . C3 are counter-propagated in direction D2 that is opposite to the first direction D1. Accordingly, the Raman amplified signals 350b from the individual cores are established due to the distributed Raman amplification in the MCF 310 from multiple depolarized optical light C1 . . . C3.

In the example of FIG. 3, three optical pumps 360, three mode multiplexers 340a . . . 340c, and three laser depolarized optical light C1 . . . C3 are used to deliver the Raman pump; however, embodiments are not limited as such. As described above, the number of optical pumps may depend on the bandwidth for the desired gain, characteristics of the optical signals to be amplified, etc. The number of depolarized optical light C1 . . . C3 used can vary, and the number selected may depend on the number and arrangement of the transmission cores in the MCF and the fiber coupler 320 used. In some embodiments, optical light, e.g., depolarized optical light C1, could be associated with a single transmission core in the MCF.

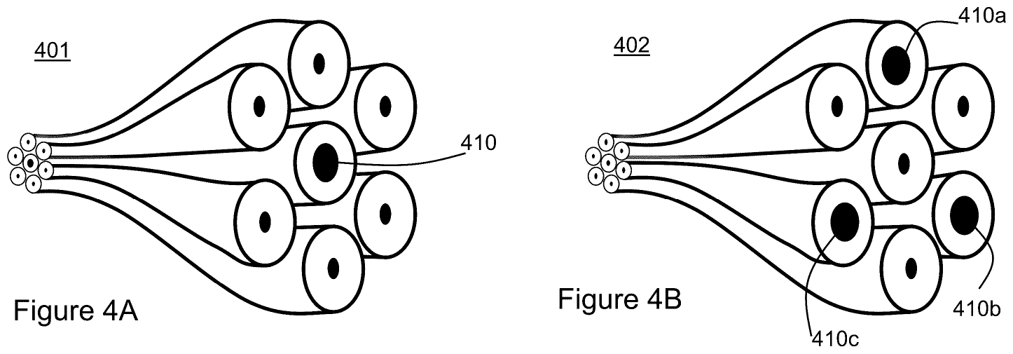

As shown above, embodiments may couple the multi-mode Raman pump(s) into the cladding of the MCF via a coupler. FIGS. 4A and 4B illustrate examples of different photonic couplers in accordance with embodiments herein. FIG. 4A illustrates a fan-out coupler 401 that may be used to couple a single optical pump light 410 into a MCF. The fan-out coupler 401 of FIG. 4A may be used as the fiber coupler 220 shown in FIG. 2. Such fan-in/fan-out couplers combine/separate the single mode cores for management of each mode individually at a node. In embodiments, the single optical pump light 410 is transmitted into the cladding of the MCF via a single core fiber of the coupler.

FIG. 4B illustrates another fan-out coupler 402 that may be used for multiple Raman pump optical light. The coupler 402 in FIG. 4B accommodates multiple Raman pumps 410a, 410b, 410c that may be used to couple the Raman pump into the cladding, or into one or more individual cores, of the MCF. The fan-out coupler 402 of FIG. 4B may be used as the fiber coupler 320 shown in FIG. 3. Here, the coupler 402 includes multiple single core fibers to couple multi-mode pump light into the cladding of the MCF.

In embodiments, the number and arrangement of the Raman pump optical light could be selected based on the number and arrangement of the transmission cores in the MCF. For example, in FIG. 4A, the MCF may contain six transmission cores arranged in a circle, while in FIG. 4B the MCF may contain four transmission cores arranged with one in the center and the remaining cores surrounding in a circle. In embodiments, a single multi-mode depolarized light may be used to provide Raman amplification in multiple cores of the MCF.

Embodiments provide a novel device and system for distributed Raman gain in a MCF. Embodiments provide an advantage for amplifying signals in MCFs, without the need to incorporate additional optical amplifiers, or amplify each core individually. Such embodiments may be particularly advantageous for MCF applications with limited access to the fibers, such as on the ocean floor. Embodiments can reduce the number of optical components by providing Raman pumping to multiple cores from a single source. For example, two cores in a MCF sharing the same Raman pump source can provide 5.7 dB of Raman gain over the entire C-band.

Unless specific arrangements described herein are mutually exclusive with one another, the various implementations described herein can be combined in whole or in part to enhance system functionality or to produce complementary functions. Likewise, aspects of the implementations may be implemented in standalone arrangements. Thus, the above description has been given by way of example only and modification in detail may be made within the scope of the present invention.

What is claimed is:

1. An optical amplifier device, comprising:
a plurality of single mode optical pumps configured to supply one or more wavelengths to a depolarizer and a mode multiplexer;
the mode multiplexer and depolarizer configured to receive the one or more wavelengths to output at least one combined depolarized optical light comprising the one or more wavelengths;
a coupler configured to couple the at least one combined depolarized optical light into a multi-core fiber (MCF),
wherein the combined depolarized optical light Raman amplifies an optical signal in the MCF.

2. The optical amplifier device of claim 1, wherein the coupler couples the at least one combined depolarized optical light into a cladding of the MCF.

3. The optical amplifier device of claim 1, wherein the coupler is a fan-out coupler comprising at least one single core fiber configured to couple into a cladding of the MCF.

4. The optical amplifier device of claim 1, wherein the mode multiplexer comprises a plurality of multiplexers that output a plurality of the combined depolarized optical light.

5. The optical amplifier device of claim 4, wherein the coupler is a fan-out coupler comprising a single core fiber for each of the plurality of combined depolarized optical light.

6. The optical amplifier device of claim 1, wherein the plurality of single mode optical pumps are configured to Raman amplify optical signals in one or more transmission cores of the MCF.

7. The optical amplifier device of claim 1, wherein the optical signal is in the C-band or L-band regions.

8. The optical amplifier device of claim 1, wherein the plurality of single mode optical pumps and the mode multiplexer are a single multimode unit.

9. An optical amplifier system, comprising:
a multi-core fiber (MCF) comprising one or more transmission cores and a cladding;
a plurality of single mode optical pumps configured to supply one or more wavelengths to a depolarizer;
a mode multiplexer configured to receive the one or more wavelengths from the depolarizer to output at least one combined depolarized optical light comprising the one or more wavelengths;
a coupler configured to couple the at least one combined depolarized optical light into the cladding of the MCF,
wherein the combined depolarized optical light provides stimulated Raman amplification to an optical signal in one or more of the transmission cores.

10. The optical amplifier system of claim 9, wherein the coupler is a fan-out coupler comprising at least one single core fiber configured to couple into the cladding of the MCF.

11. The optical amplifier system of claim 9, wherein the mode multiplexer comprises a plurality of multiplexers that output a plurality of the combined depolarized optical light.

12. The optical amplifier system of claim 11, wherein the coupler is a fan-out coupler comprising a single core fiber for each of the plurality of combined depolarized optical light, wherein each single core fiber is configured to couple into the cladding of the MCF.

13. The optical amplifier system of claim 9, wherein the optical signals are in the C-band or L-band regions.

14. The optical amplifier system of claim 9, wherein the plurality of single mode optical pumps and the mode multiplexer are a single multimode unit of the system.

15. A method of providing distributed Raman amplification in a multi-core fiber (MCF), the method comprising:
transmitting a plurality of single mode optical pump light of one or more wavelengths to a depolarizer;
receiving, a mode multiplexer, the one or more wavelengths from the depolarizer;
multiplexing the one or more wavelengths,
transmitting at least one combined depolarized optical light comprising the one or more wavelengths to a coupler;
coupling the at least one combined depolarized optical light into a cladding of the MCF, and
amplifying, by stimulated Raman amplification, an optical signal in one or more transmission cores of the MCF using the combined depolarized optical light.

16. The method of claim 15, wherein the coupler is a fan-out coupler comprising at least one single core fiber configured to couple into the cladding of the MCF.

17. The method of claim 15, wherein the mode multiplexer comprises a plurality of multiplexers that output a plurality of the combined depolarized optical light.

18. The method of claim 17, wherein the coupler is a fan-out coupler comprising a single core fiber for each of the plurality of combined depolarized optical light.

19. The method of claim 15, wherein the optical signals are in the C-band or L-band regions.

20. The method of claim 15, wherein the plurality of single mode optical pumps and the mode multiplexer are a single multimode unit.
